(19) United States
(12) Patent Application Publication
(10) Pub. No.: US 2010/0325173 A1
(43) Pub. Date: Dec. 23, 2010

(54) RAPID DEVELOPMENT OF INFORMATICS SYSTEMS FOR COLLABORATIVE DATA MANAGEMENT

(75) Inventors: Robert W. Haley, Dallas, TX (US); William Wesley Marshall, Frisco, TX (US)

Correspondence Address: FULBRIGHT & JAWORSKI L.L.P., 600 CONGRESS AVE., SUITE 2400, AUSTIN, TX, 78701, US

(73) Assignee: The Board of Regents of the The University of Texas System, Austin, TX (US)

(21) Appl. No.: 12/821,913

(22) Filed: Jun. 23, 2010

Related U.S. Application Data
(60) Provisional application No. 61/219,635, filed on Jun. 23, 2009.

(51) Int. Cl. G06F 17/30

(52) U.S. Cl. 707/804; 707/E17.005

(57) ABSTRACT

Rapid development of a collaborative database uses a spreadsheet application to implement the database. Each parameter of the database variables is entered into a corresponding cell in the spreadsheet. A first spreadsheet code is entered that refers to selected cells related to a first variable and resolves into database code that instructs a database application to create the first variable in the collaborative database. A second spreadsheet code is also entered also referring to selected cells related to the first variable and resolves into application server (AS) code that instructs an application server to generate a graphical data entry form for that variable. In order to develop the same database and AS code for the remaining variables, the developer uses the autofill function of the spreadsheet to autofill the spreadsheet codes to cells related to the other variables and resolving into their own database and AS codes.

### CROSS-REFERENCE TO RELATED APPLICATIONS

This application claims the benefit of U.S. Provisional Patent Application No. 61/219,635, entitled, “RAPID DEVELOPMENT OF INFORMATICS SYSTEMS FOR COLLABORATIVE DATA MANAGEMENT”, filed on Jun. 23, 2009, which is expressly incorporated by reference herein in its entirety.

### TECHNICAL FIELD

The present teachings relate, in general, to electronic data management, and, more particularly, to rapid development of informatics systems for collaborate data management.

### BACKGROUND

The collection and management of data touches on almost every aspect of human life. From the body's electrical and chemical receptors gathering status information for the brain to manage the body's operation, to telemarketers questioning the public for a political poll, the collection and management of data is intertwined in human existence. Because of their ability to process data well, computers and computer technology have excelled at the organization and management of data. Data organization and management is now almost routinely handled with electronic databases. A database is a structured collection of records or data that is stored in a storage or memory device attached to or embedded in a computer system. The structure is achieved by organizing the data according to a database model. The model in most common use today is the relational model. Databases that are structured according to the relational model are often referred to as relational databases. A relational database is a collection of data items organized as a set of formally-described tables from which data can be accessed or reassembled in many different ways without having to reorganize the tables. The database tables include unique identifiers which may be used to assemble customized reports of data from across multiple tables. Examples of relational database products include Sun Microsystems' MYSQL®, Microsoft Corporation's ACCESS® and SQL SERVER™, Sybase Inc.'s SYBASE®, and the like.

Additional types of databases include those structured according to the hierarchical model, network model, and the like. The hierarchical model, such as found in IBM's Information Management System (IMS™), develops a database where the data or information has a tree-like structure with parent-child relationships. In a hierarchical database, a parent can have multiple children, but a child may only have a single parent. This is in contrast to the network model database which is also organized as a tree structure, but in which data items may have multiple parent-child relationships. An example of a network model database is Computer Associates Inc.'s Integrated Database Management System (IDMS™), originally developed by the B.F. Goodrich Company.

The database architecture provides for the structured collection of the data. However, the usefulness of any particular database is typically derived from the database management system (DBMS) software that is used to actually organize the storage and retrieval of the information within the database. DBMS software typically includes a query language that may be used to enter commands for some kind of data manipulation within the database. For example, structured query language (SQL) is a database computer language designed for the retrieval and management of data in relational database management systems (RDBMS), database schema creation and modification, and database object access control management. SQL allows the retrieval, insertion, updating, and deletion of data.

Through use of a query language, such as SQL, in a relational database, information users may more easily and more efficiently manage the data. However, before the information in the database may be utilized, the database itself needs to be designed and implemented. Relational databases are made up of multiple tables in which each table has certain property values that will relate to property values in other tables. By creating a network of relations between these multiple tables of data, the data can be more easily searched, manipulated, managed, and the like. Designing a relational database for a simple data management project having only a few data variables may only involve a few tables with a few relations between them. Such simple database design may be accomplished by individuals with a little computer and electronic database experience.

In contrast, however, larger data management projects, which could entail gathering and managing data from a chemical plant, gathering and managing data from a financial business, gathering and managing data from a medical research study, or the like, will typically entail numerous tables having complex relationships and associations, and possibly even security issues that dictate the manner in which data is divided into the tables or the manner in which data takers enter the data into the system. The DBMS systems that can even handle such complex relationships may cost in the hundreds of thousands and even into the millions of dollars. Such complex database systems also generally require a team of highly skilled database developers and database programmers to design, build, maintain, and manage the system. Additionally, once these complex systems have been put in place, any changes that may be desired would generally take considerable time to implement and will usually trigger additional testing to ensure that the complexity and integrity of the database has been maintained. Therefore, changes to such large and complex database systems are often discouraged.

These large databases are often critical to the underlying businesses they support. Therefore, highly-skilled database developers and programmers are sought after, which tends to drive the overall cost for creating and maintaining the database system even higher. Moreover, because of the complex nature of the tables and relationships between the tables, creating the database may take a very long time to program and test the final product for accuracy and reliability. Therefore, it is conceivable that the time it takes to create and test a large database management system would exceed the time allotted for the actual data analysis project. These high cost considerations, both in time and money, often discourage companies from instituting programs or studies that require such support, which for a retail company could diminish its ability to experience economic growth, or, for a medical research study, delay a solution to a pressing medical problem.

### BRIEF SUMMARY

The various embodiments of the present teachings provide for rapid development of a collaborative database management system (CDMS) using a spreadsheet application. In one of the active worksheets of a spreadsheet application, a design template is created which contains a number of columns that describe the variables to be collected by the investigator. The different columns describe such key design information as variable name, variable description, variable type, variable width, number of decimal places, the units, whether the information is required, valid range of entries, notes on the variable, and the like. The tester/investigator starts on a given row and types in all of the parameters for the first variable. This process is repeated for the second row (variable) and so forth, until the tester/investigator has typed in all of the parameters for the rows (variables).

After this list of variables has been entered into the template worksheet, the designer/developer inserts additional columns to the design worksheet constituting formulas of spreadsheet-compatible programming code, which will resolve into the database application code and application server (AS) code needed to construct the CDMS. For example, the designer/developer would enter this code in the top most cell of the respective columns, i.e., in the first row representing the first variable.

In order to obtain the database application code, the designer/developer enters spreadsheet functions and database code into this top most cell of the column that will contain database application code for the worksheet. The spreadsheet functions and database code reference the row-adjacent tester/investigator-entered parameters in the first row describing the first or top most variable. The spreadsheet code describes relationships or makes calculations or conditional evaluations based on the content of selected parameters in that row. When the spreadsheet application evaluates or resolves the entered spreadsheet functions, the result, displayed in the cell, is database code that includes the content of the selected cells relating to the particular variable. After testing and debugging this resulting database code for the first selected variable, the database designer uses the autofill functionality of the spreadsheet application to intelligently fill the same spreadsheet code for selected ones of the remaining database variables in the database application code column of the worksheet. The resulting code displayed in the associated cells provides the database code instructions for a database application to create each of the variables designed for the database. Thus, the user/designer has only coded the spreadsheet application code that generates the database code for a single variable from within the spreadsheet application, but is able to automatically apply that spreadsheet code to the remaining variables to automatically generate the rest of the database code instructions.

In order to obtain the AS code, the database designer enters additional spreadsheet functions and AS code into the top most cell of the column that will contain the AS code for the worksheet. The spreadsheet functions and AS code reference additional row-adjacent parameters in that first row of parameters describing the first selected variable. The AS code provides instructions for building a visual presentation related to the first selected variable. When the spreadsheet application evaluates or resolves this new spreadsheet code, the resulting code displayed in the cell comprises the AS code that instructs a compatible application server to generate a data entry form for that selected variable. Again, after testing and debugging the spreadsheet code and its resulting AS code, the developer autofills the spreadsheet code for all of the remaining variables. The result of this autofill process provides the AS code to generate a data entry form for each variable of the database.

After completing the autofill processes to create the database code and AS code, the developer copies the database code for execution in a database application. The database application runs the code and creates the database tables according to the variable design from the spreadsheet application. Similarly, the developer copies the AS code to an application server environment for execution. The application server environment installs or publishes the AS code to the web server hosting the application server that manages the database. When authorized testers thereafter request access to the database, the application server runs the AS code, generates the data entry form, and transmits the form back to the tester. The tester then enters the appropriated data in the form. When the tester finishes entering the data, the form is transmitted back to the application server, which, based on data mapping instructions contained within the AS code, the application server is able to populate the appropriate tables within the database with the data entered by the tester.

The foregoing has outlined rather broadly the features and technical advantages of the present teachings in order that the detailed description that follows may be better understood. Additional features and advantages will be described hereinafter which form the subject of the claims of the teachings herein. It should be appreciated by those skilled in the art that the conception and specific embodiment disclosed may be readily utilized as a basis for modifying or designing other structures for carrying out the same purposes of the present teachings. It should also be realized by those skilled in the art that such equivalent constructions do not depart from the spirit and scope of these teachings as set forth in the appended claims. The novel features which are believed to be characteristic of the present teachings, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present teachings.

### BRIEF DESCRIPTION OF THE DRAWINGS

For a more complete understanding of the present teachings, reference is now made to the following descriptions taken in conjunction with the accompanying drawing, in which:

FIG. 1 is a block diagram illustrating a collaborative data management system (CDMS);

FIG. 2 is a block diagram illustrating detail of the web server 102 and centralized database depicted in FIG. 1;

FIG. 3 is a block diagram illustrating a developer computer configured according to one embodiment of the present teachings;

FIG. 4 is a flowchart illustrating example steps executed to implement one embodiment of the present teachings;

FIG. 5 is a screenshot illustrating an active sheet configured according to one embodiment of the present teachings;

FIG. 6 is a screen shot illustrating the database code column of the active sheet from FIG. 5 configured according to one embodiment of the present teachings;

FIG. 7 is a screen shot illustrating the application server (AS) code column of the active sheet from FIG. 5 configured according to one embodiment of the present teachings;

FIG. 8A is a block diagram illustrating a CDMS generated according to one embodiment of the present teachings;

FIG. 8B is an idealized diagram illustrating an organizational structure of the database generated according to one embodiment of the present teachings;

FIG. 9A is a block diagram illustrating a CDMS created and configured according to one embodiment of the present teachings;

FIG. 9B is an idealized diagram illustrating the organizational structure of the database generated according to one embodiment of the present teachings; and

FIG. 10 illustrates an exemplary computer system which may be employed to implement the developers computer or web server therein according to certain embodiments.

### DETAILED DESCRIPTION

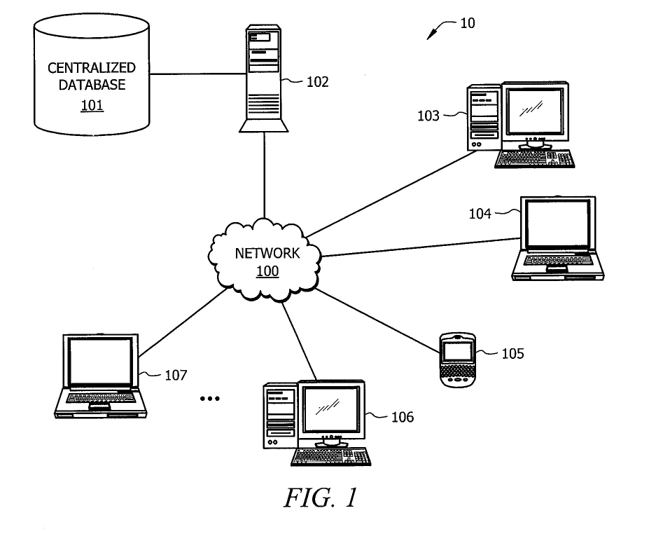

Turning now to FIG. 1, collaborative data management system (CDMS) 10 is illustrated. Network 100, which may be a private intranet, the public internet, or the like, is coupled to centralized database 101 through web server 102. Web server 102 manages interactions between centralized database 101 and a user requesting to access or modify the data stored in centralized database 101. Users, such as the users at computing devices 103-107, access the data in centralized database 101 via network 100. For example, the user at computing device 103 desires to view a particular report of some of the data stored on centralized database 101. Computing device 103 connects to network 100 and transmits a communication request to web server 102. Once the appropriate electronic handshaking has been completed, a data request is then transmitted between computing device 103 and web server 102. The data request may be formatted using a database query language, such as SQL. Web server 102 interprets the instructions in the data request and retrieves the particular data responsive to the request from centralized database 101. Web server 102 then generates a visual display page that includes the retrieved data and transmits the entire package of information back to computing device 103. A user interface application running on computing device 103 interprets and implements the display page that includes the requested data by rendering the visual presentation to the user on a display of computing device 103.

Another operation that regularly occurs in CDMS 10 is the addition of data. In highly collaborative systems, it is often desirable to implement data entry through predesigned graphical data entry forms. Data entry forms are specific user interface tools which provide a data entry field on a graphical user interface into which the user records particular data. The user interface screen may further have a textual description of what kind of data is expected in the field. For example, the display screen on computer device 105 may display the phrase, “Heart Rate” next to a entry field. The user, then, knows to enter a value for the heart rate in this entry field. Within the code defining the data entry form are mapping instructions that instruct the application server where in the database, to add the data stored in that particular field. Here, the field designated for the heart rate is mapped to the associated table in centralized database 101. Thus, when the user is finished with the entry form, computer device 105 packages up the data entry form along with the entered data and transmits it to web server 102. Web server 102 unpacks the data entry form and, using the mapping information for each data entry field, adds the user-entered data to the appropriate table within centralized database 101. Therefore, the addition of the data to centralized database 101 is controlled by the instructions found in the data entry form. This process relieves the users from manually entering any particular data directly into the database, which could risk adding errors. Moreover, by limiting direct access to the database, data is further insulated from unauthorized access.

In addition to the mapping instructions in the data entry form, additional information may be added in order to perform validation on the data before it is actually added to centralized database 101. If the associated table in centralized database 101 is defined for an integer, it will expect to receive integer input. If it receives a text format instead, an error will occur as the user/tester enters the data. Therefore, data types may be set in advance onto the data entry form, such that, if a user at computer device 105 mistakenly enters text in the heart rate data field, the data entry form includes simple logic that will identify the error to the user, so the user may correct the mistake on the data entry form before the mistake is propagated to centralized database 101. Similarly, simple logic may be added to the data entry form to ensure that the data entered is within an expected range. For example, if a particular data entry form is used to enter, among other things, the pressure reading of a certain steam boiler, a range of pressure may be given. If a maximum sustainable pressure in the boiler is 3,000 p.s.i., then a high end to the range may be entered as 2,500 p.s.i. Therefore, if the user mistakenly enters 12,100 p.s.i. into that data entry field, the logic in the data entry form will signal the user of the mistake, thereby allowing the user to fix the entry before the mistake is introduced into centralized database 101.

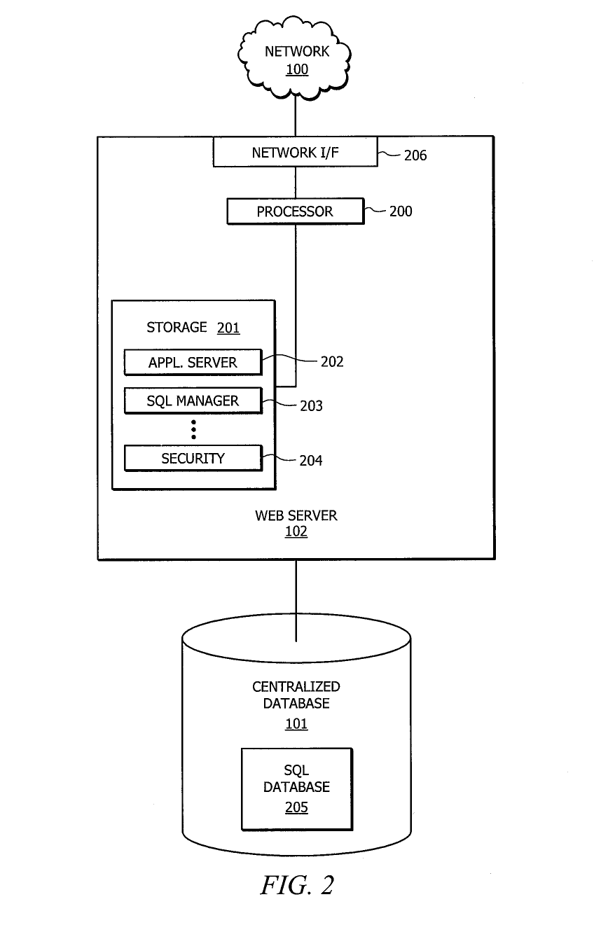

FIG. 2 is a block diagram illustrating a detail of web server 102 and centralized database 101. Web server 102, as illustrated, includes processor 200, storage memory 201, and network interface 206 which enables communication between web server 102 and network 100. Multiple applications are stored on storage memory 201 that facilitate the functionality of web server 102, e.g., application server 202, SQL manager 203, security application 204, and the like. When executed by processor 200, application server 202 provides a dynamic web interface for generating data reports, data entry forms, and the like, based on the particular request received from the user's computing device. Examples of application servers are Adobe Systems Incorporated's COLDFUSION®, Oracle, Inc.'s WEBLOGIC SERVER®, Apache Software Foundation's APACHE GERONIMO™ server, Microsoft Corporation's .NET FRAMEWORK®, and the like. When executed by processor 200, SQL manager 203 provides the management interface with SQL database 205 stored on centralized database 101. Therefore, when application server 202 seeks to read or write data from SQL database 205, it processes those requests through SQL manager 203. SQL manager 203 performs the particular tasks with SQL database 205 and returns the results to application server 202. When executed by processor 200, security application 204 provides security functionality such as, for example, by implementing transport layer security, secure sockets layer, or other similar cryptographic security measure aimed at maintaining the security and data integrity in communications over network 100.

It should be noted that additional or alternative embodiments of web server 102 may include various additional parts, applications, functionalities, and the like. The configuration described with regard to FIG. 2 provides a simple compatible server architecture; however, various other server architectures may also be compatible.

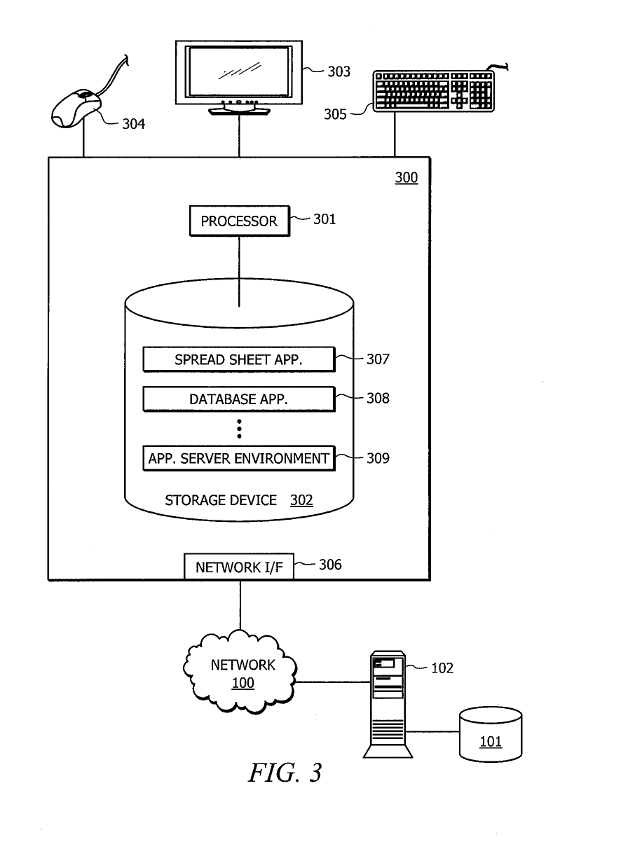

FIG. 3 is a block diagram illustrating developer computer 300 configured according to one embodiment of the present teachings. Developer computer 300 includes processor 301, storage device 302, display device 303, and user input devices 304 and 305. Network interface 306 is also included and enables communication between developer computer 300 and network 100. Several applications used to develop a particular CDMS are stored on storage device 302, e.g., spreadsheet application 307, database application 308, application server environment 309, and the like. When executed by processor 301, spreadsheet application 307 generates a spreadsheet environment that provides such spreadsheet functionality as arithmetic, formula, cell logic, and the like. Spreadsheet functionality is well known. One of many examples of spreadsheet applications that are compatible with the present teachings is Microsoft Corporation's EXCEL®. When executed by processor 301, database application 308 facilitates communications between developer computer 300 and web server 102. A developer may use database application 308 to create SQL database 205 (FIG. 2) stored on centralized database 101. When executed by processor 301, application server environment 309 provides the development environment for generating an application server, such as application server 202 (FIG. 2) on web server 102. Examples of an application server environment include COLDFUSION® and DREAMWEAVER®, also from Adobe Systems Incorporated, and the like.

Typically, database developers would use database application 308 to directly create the database for any particular collaborative research study or data management system. The developer would also typically use application server environment 309 to generate the CDMS interface, data entry forms, and report forms for browser-based data access. However, in the various embodiments of the present teachings, the developer uses spreadsheet application 307 to design the entire CDMS.

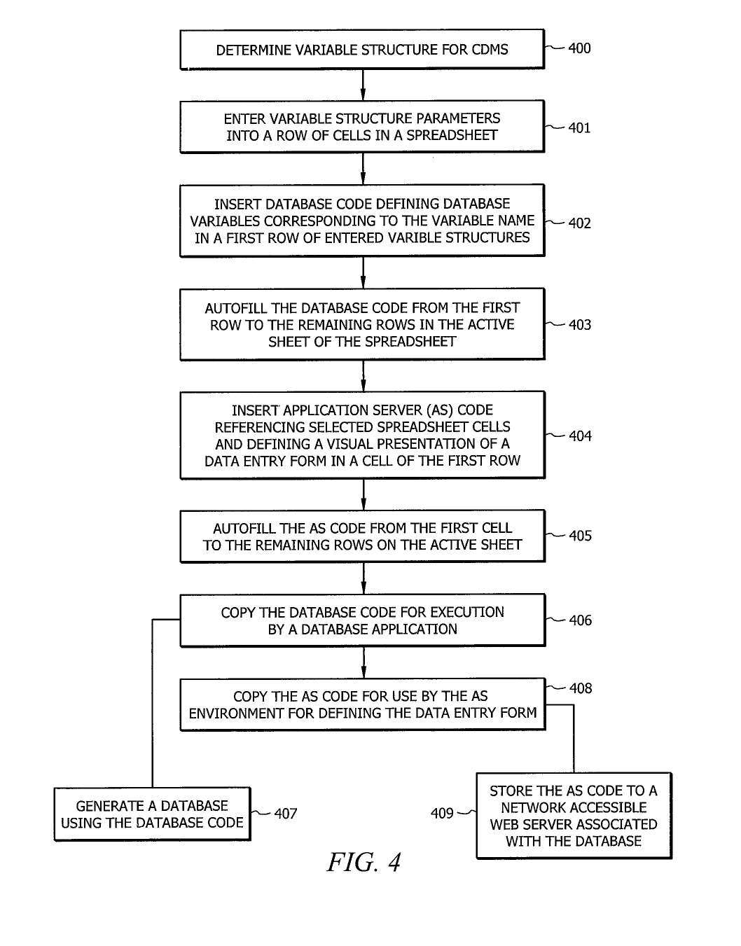

FIG. 4 is a flowchart illustrating example steps executed to implement one embodiment of the present teachings. In step 400, the structure of the variables of the database is determined. This step may involve various different steps such as determining the variable names, what the variable is for, the variable type, character length, allowable range, units, and the like. Depending on the intended purpose of the database, the determination of the variable structure may be performed by a single database developer, by individual data collectors, or a combination of these and other individuals. Once the variable structure has been determined, the structure parameters are entered into one or more rows of cells in an active sheet of a spreadsheet in step 401. The developer enters each parameter in a separate cell for a particular row; one row per variable.

It should be noted that in additional and/or alternative embodiments of the present teachings, each variable may be assigned to cells in a column. The various embodiments of the present teaching are not limited to a particular set up.

In step 402, the developer inserts spreadsheet code that will resolve into database code into one of the cells in the first row of entered variable structure parameters, where the resulting database code will instruct a database application to create the corresponding row variable in the database. The database code is generated in a specific query language, such as SQL, and references certain spreadsheet cells in the row for the purpose of defining the variable in the eventual database structure. The code that is designed and inserted by the developer is written with both spreadsheet functions and database code. The spreadsheet functions leverages the functionality of the spreadsheet application to perform basic conditional logic and concatenation using the text written as the database code and cell contents. Thus, when the developer enters the spreadsheet code including the database code and cell references, the spreadsheet resolves the formula with the referenced cell content and database code and displays those results in the spreadsheet cell. This resulting displayed code is the database code.

In step 403, the autofill functionality of the spreadsheet is used to fill the spreadsheet code that generates database code into corresponding cells for the remaining rows of entered variable structure parameters. The resulting database code cells form a column in the active sheet. Autofill functionality, as that term is used herein, means the automatic fill functionality present in various spreadsheet applications, such as EXCEL®. Using the autofill functionality, the developer selects the cell having the spreadsheet code that generates database code inserted there in and then drags an autofill handle or other such visual interface cue across either the adjacent cells in a row or adjacent cells in a column. The cells that have been dragged across are then automatically filled with a version of the spreadsheet code based on the first cell. Autofill is similar to a copy functionality. However, it does not simply copy cell content from one cell to other adjacent cells. Instead, autofill analyzes the selected cell content and modifies the content that is filled into the other adjacent cells based on any detected series or pattern, or based on relationships between the variables and cells present in the initially selected cell or cells. For example, if the selected cell at grid location D3 includes a formula for adding the cell contents of cells, A3, B3, and C3, then, when cells D4 and D5 are autofilled, their respective filled formula would be: A4+B4+C4; and A5+B5+C5. Thus, autofill changed the row addresses for the formula according to the relationship between the highlighted column in the autofill, i.e., D3, D4, and D5.

After autofilling the spreadsheet code that generates database code in step 403, each cell in the database code column includes query language code executable by a database application to generate the related variable structure in the resulting database. The developer has, thus, been able to code the variable constructor that will define the first variable in the resulting database and re-use the same code structure through the autofill to generate the applicable database code for the remaining variables. This process substantially cuts down on coding time for generating the particular database.

In step 404, spreadsheet code that generates application server (AS) code is inserted in the first cell of another column that references the first row of entered variable structure parameters. The AS code is generated in the computer language native to the application server that will be used to provide network access to the database and defines the visual presentation for that particular variable in a graphical data entry form. The spreadsheet code provides references to cell address in the first row that will be used in the presentation. The spreadsheet code in the first row is autofilled into corresponding cells for the remaining rows of entered variable structure parameters and is resolved into the applicable AS code. The filled AS code cells also form a column in the active sheet. As noted above, the developer has been able to code the display characteristics for each variable that will be displayed on the data entry form by using spreadsheet code to generate the AS code for the first variable and autofilling the code for the remaining variables based on the first variable. This process substantially cuts down on coding time for generating the data entry screens.

The database code is copied and transferred, in step 406, for execution by a database application, which uses the code and cell references to generate a database, in step 407, organized according to the variable structure determined in step 400. Similarly, the AS code is copied and transferred, in step 408, for use by an application server environment for defining the visual presentation of the data entry form. This AS code is then stored, in step 409, to a network-accessible web server associated with the database created in step 408. When a user requests to enter data into the database, an application server running on the web server executes the AS code and serves a visual presentation of a data entry form to the user. The user may then enter the measured or observed data into the form. On completion of the data entry, the form returns the data entry form to the web server which reads the data binding information for each data entry field in the form and adds the data to the specific table or place in the database.

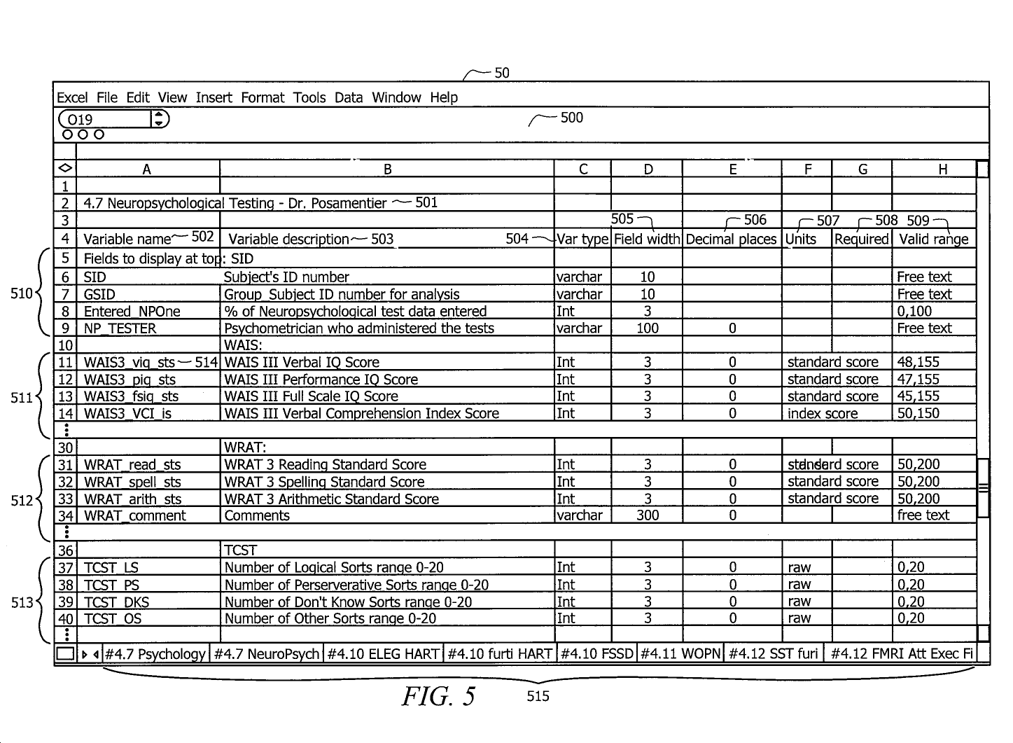

FIG. 5 is a screenshot illustrating active sheet 500 configured according to one embodiment of the present teachings. A CDMS designer has created active sheet 500 using spreadsheet application 50. Active sheet 500 relates to a medical research study in which multiple testers will take and record patient data into the CDMS system. Active sheet 500 includes active sheet title 501 which identifies active sheet 500 as the neuropsychological testing to be performed or monitored by Dr. Kildare. Columns are labeled to identify the various entries found in active sheet 500. The columns include variable name 502, variable description 503, variable type 504, field width 505, decimal places 506, units 507, required 508, and valid range 509. The variables and their properties are entered in rows across active sheet 500. Administrative variables 510 include the variables used to identify the test subject, the group identification number, the percentage of the test data that has been entered, and the party who administered the test. This information is used in securing or restricting access to certain information and for identifying the origin of the test data.

WAIS variables 511 provide the multiple test data/variables in the WAIS category. Similarly, WRAT variables 512 and TCST variables 513 each provide database entries for those associated test data. Turning to row 11 for named variable WAIS3_viq_sts 514, active sheet 500 lists that WAIS3_viq_sts 514 is the WAIS III verbal IQ score, that it has an integer variable type with a field width of 3 characters and no decimal places. Its units are a standard score unit with a blank indicated in required column 508 and a valid range between 48 and 155. This variable structure information may be used to set up the database using the correct data types, sizes, and value ranges, as well as being instructive to what the variable actually is. Sheet interface 515 illustrates different tabs for different data entry projects or different testers.

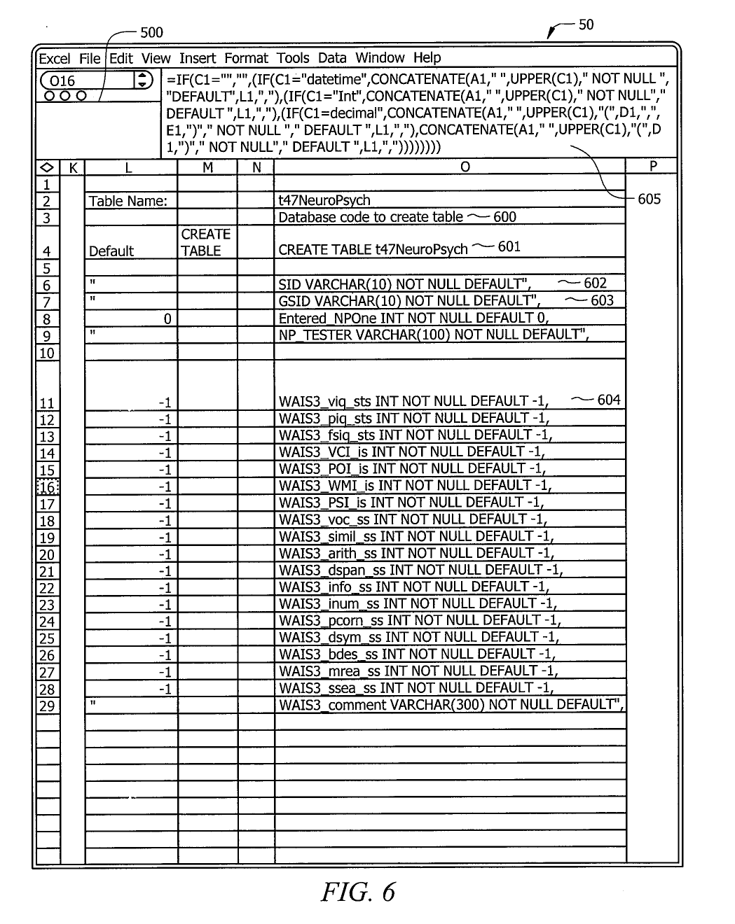

FIG. 6 is a screen shot illustrating database code column 600 of active sheet 500 configured according to one embodiment of the present teachings. Active sheet 500, again illustrated in spreadsheet application 50, continues with database code column 600. The cell contents of each used cell in database code column 600 includes database code that defines and constructs corresponding variable and table structure in a related and resulting database. For example, in row 4, the database code cell 601 provides the instruction for the database application to generate a new table called “t47NeuroPsych.” Similarly, database code cells 602 and 603 provide the instructions for the database application to initialize administrative variables 510 (FIG. 5).

The instructions, though, are generated through the processing of the spreadsheet code entered in cell input field 605. The instruction in database code cell 604 is not directly entered by the developer, but is instead generated through a spreadsheet code formula based, in the given embodiment, on the various states of the variable properties. Through a series of conditional “If' and “concatenate” statements, the spreadsheet formula entered in cell input field 605 analyzes the condition of the identified variables and generates the database code accordingly. For example, in the case of an integer type, if cell C11 states “int”, then spreadsheet 50 concatenates cell A11, which is the variable name, WAIS3_viq_sts, with the uppercase of the contents of cell C11, with the phrase “NOT NULL”, followed by the word “DEFAULT” followed by the contents of cell L11 (−1). When this spreadsheet formula, entered in cell input field 605, is run on the row entries of variable WAIS3_viq_sts 514, the resulting text is displayed in database code cell 604, “WAIS3_viq_sts INT NOT NULL DEFAULT−1,”. Thus, the database code is automatically generated by running the formula on the variable structure entries. Instead of rewriting this code for each variable in active sheet 500, the designer writes the spreadsheet formula in cell input field 605 to be placed in database code cell 604. The developer can then test and debug the spreadsheet formula there until it operates properly. The developer will then autofill the spreadsheet formula for the remaining cells in database code column 600 that the developer indicates. Once the spreadsheet formula enters those individual cells maintaining the relative relationship from database code cell 604, each of the cells in database code column 600 reflects the appropriate database code.

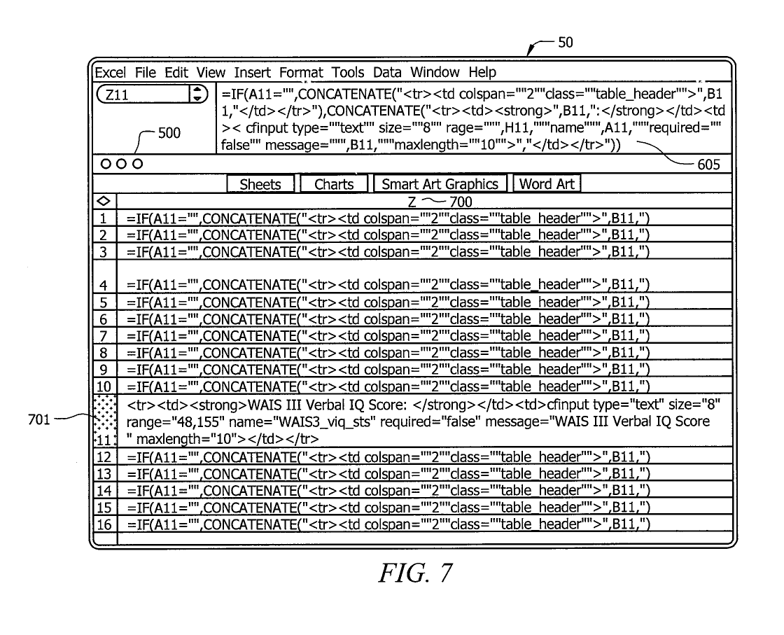

FIG. 7 is a screen shot illustrating AS code column 700 of active sheet 500 configured according to one embodiment of the present teachings. AS code cell 701 presents the AS code related to variable WAIS3_viq_sts 514 (FIG. 5). As noted above, with respect to FIG. 6, the code displayed in AS code cell 701 is not entered directly by the CDMS designer. Instead, spreadsheet code is entered into cell input field 605. This spreadsheet code references various cells that it uses to make conditional determinations, to print/display content from, and the like. Cell input field 605 contains the following formula: =IF(A11=””, CONCATENATE (“<tr><td colspan=”“2”” class =“”table_header””>”, B11, </td</tr>”), CONCATENATE(“<tr><td><strong>”, B11,”: </strong></td><td><cfinput type=“text”” size=“”8”” range=””, H11,””” name=“””, A11,””” required=“”false”” message=“””, B11””” maxlength=“”10””>”,” </td></tr>”)). The cell references in this formula along with the execution of the spreadsheet code, produces the following AS code in AS code cell 701: <tr><td><strong>WAIS III Verbal IQ Score: </strong></td><td><cfinput type=“text” size=“8” range=“48,155”, name=“WAIS3_viq_sts” required=“false” message=“WAIS III Verbal IQ Score” maxlength=“10”></td></tr>. This resulting AS code takes into account the variable name (A11), variable description (B11), and the range (H11). Thus, again, the AS code is automatically generated by running the spreadsheet formula on the variable structure entries. Instead of rewriting this code for each variable in active sheet 500, the designer writes the formula in cell input field 605 to be placed in database code cell 604. Once the formula enters those individual cells maintaining the relative relationship from AS code cell 701, each of the cells in AS code column 700 reflects the appropriate AS code.

The processes illustrated in FIGS. 6 and 7 define a procedure in which the developer designs the spreadsheet formula that generates the database and AS code only once each, but then reuses and autofills that spreadsheet formula/code for all of the other data and variable structures defined for the CDMS. This “code once, use many” design paradigm saves considerable development time and provides a more efficient way to test the code once and then reproduce the adapted code automatically while also as error free as the first set of code. FIGS. 5-7 each illustrate a screen shot of an active sheet of variables intended to be handled by one tester. Referring back to sheet interface 515, many of the CDMS systems are intended for multiple testers. The same spreadsheet formula can be copied to the other sheets representing the other testers in sheet interface 515 (FIG. 5) with the same autofill functionality repeated, thus, allowing the developer to code for a single variable row in one sheet for one tester and then copy and autofill that cede for additional testers with separate sheets and multiple, multiple variable rows.

With more and more data becoming available over public networks or private networks that are susceptible to unauthorized access or release of data, security has become a paramount issue in the management of data, especially personal data, on any given networked system. For example, in government agency matters, enhanced security requirements have been established for vendors based on unauthorized release of sensitive information through lacks security or lapses of government vigilance. One example of such enhancements is with vendors doing business with the Veterans Administration (VA). Any person or entity that deals with the VA has to change its environment to have robust information technology security. The National Institute for Health (NIH), Food and Drug Administration (FDA), and the like are also beginning to increase security requirements, especially when sensitive personal financial and/or medical information is at risk. Sensitive health-related information is already subject to restrictions based on the Health Insurance Portability and Accountability Act (HIPAA). New standards, such as the Federal Information Processing Standard (FIPS), and the Federal Information Security Management Act (FISMA), also provide important enhanced security standards that any party dealing with data management for or on behalf of the government will be required to meet at some point in the relationship.

In a highly collaborative environment, where there will be multiple persons or locations capable of entering data, security issues may also arise in maintaining data integrity between individual testers/users. Maintaining data security does not simply start and stop with adding a good encryption application or system access controller. The architecture and configuration of any networked computer system may also add to security considerations. In the health and medical fields, practically all new grant money available from the NIH, Health and Human Services (HHS), Department of the Defense (DOD), and the VA will require the data to be collected and stored in a HIPAA-compliant method. These methods prohibit or discourage storage of personal health information in mobile computers, local access databases, and the like. Managing information in this manner does not comply with any of HIPAA, FISMA, or FIPS. Providing easy network access to a CDMS that still meets HIPAA, FISMA, and/or FIPS security requirements requires becomes a difficult transaction. One architecture that has shown to be compliant with the stricter governmental security requirements begins by using a centralized relational database having available network access to it. However, access to the database is provided through an application server. Therefore, access is controlled based on the application server code. Testers/users cannot simply enter a uniform resource locator (URL) and obtain access to the data. Specific codes and scripts are passed between the tester's computer and the application server. The application server then uses those codes to retrieve responsive data from the database and generate a visual presentation of the database that can be displayed on the tester's web browser or other such media player. The actual data does not get downloaded to the user's computer. Therefore, when the access session has been completed the data will not remain on the tester's computer.

The architecture of the database also provides a level of security. The data tables provide a separation between personal health information (PHI) and individual identifying information (III) into separate and unique tables. Non-identifying reference numbers are used to eventually tie the data to the individual and field level encryption, such as a FIPS 140-2 compliant encryption algorithm, is used to encrypt any information that may identify the test subject. The CDMS is designed by building a unique table for each tester/user in the database. The information in that tester-specific table is linked by the non-identifying subject ID for a given patient or test subject. The subject ID allows the tester to associate the test data with the particular test subject, but it does not allow the tester to access the subject's III in the subject table. Therefore, individual testers may still have complete access to test results for analysis, just not in a way that would allow identification of the individual test subject.

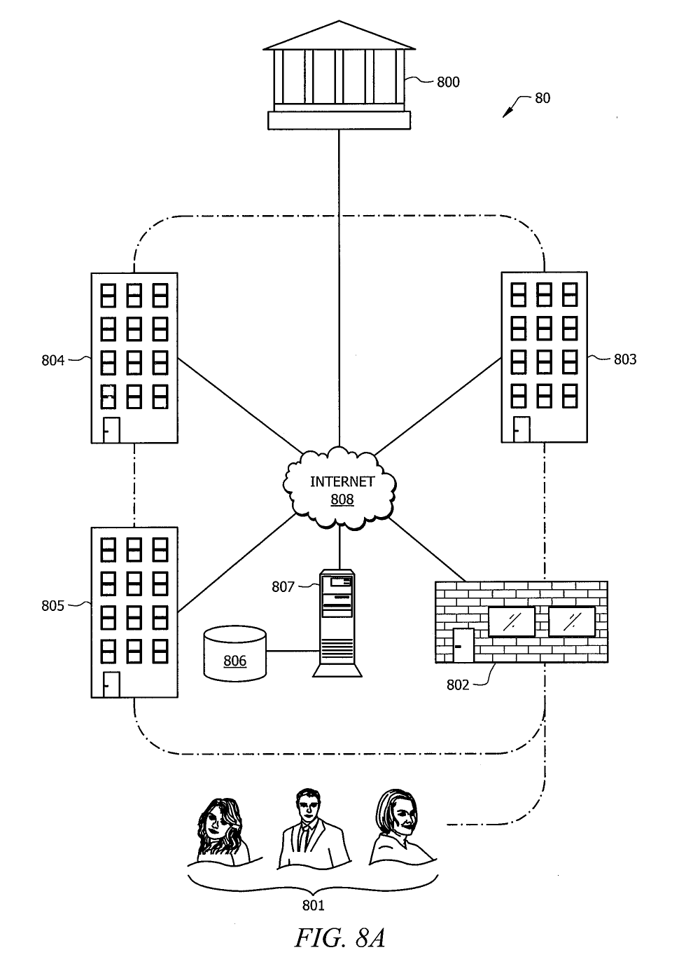

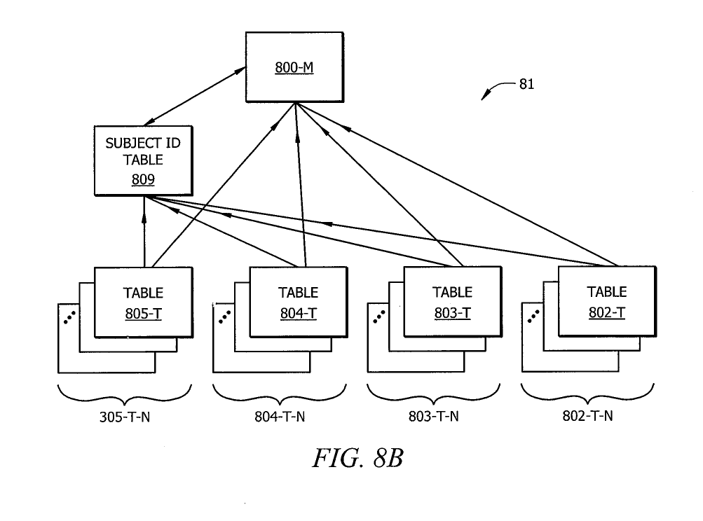

The rapid development process and resulting CDMS may be applied in any data intensive project in which multiple parties will collaborate on entering data to a centralized database. One example application of selected embodiments of the present teachings is in medical research studies. FIG. 8A is a block diagram illustrating CDMS 80 generated according to one embodiment of the present teachings. Principal researchers at research institute 800 devise a test protocol for researching a certain disease. The protocol calls for a number of test subjects, patients 801, to visit and be tested by a number of doctors at test facilities 802-805. Doctors at test facilities 802-805 will test and record test results on patients 801 in some of the doctors will be taking and entering test result information on some of the same ones of patients 801 as other doctors in test facilities 802-805.

In the development stage of the test protocol, the principal researchers at research institute 800 work with individual doctors at test facilities 802-805 to come up with a template of data listing each test and test result that each particular doctor believes needs to be taken for purposes of the test protocol. As each of the templates is finalized for each of the doctors, a database developer at research institute 800 designs the CDMS using his or her spreadsheet program. First, the database developer enters the variable parameters from the finished templates. The developer uses a separate worksheet for each doctor's template. The template for a medical research study is made up of a list of variables and the variables' parameters. Parameters for such variables would include a variable name for each piece of test data that the doctor selected for testing, a description of that variable, the variable type (i.e., whether it will be a text field, an integer, a decimal, and the like), field width, decimal places (if applicable), units, valid range, and the like. These parameters are what the database developer enters into the active sheet.

In order to make the work sheets readable, the developer may include titles, column and/or row headings, and other instructive information. For entering the variable parameters, the developer organizes the worksheets by placing all of the parameters for a given variable in a single row. Columns are given headings to make the parameters easier to discern. Once the developer enters each of the variables and the rows of associated parameters, he or she selects an open cell in the row of the first variable. Using a combination of spreadsheet code interspersed with database code, the developer writes a formula to the open cell that provides conditions based on various of the parameters of the variable and then subsequent concatenating actions dependent on the resolution of the conditions. When the developer finishes entering this spreadsheet code formula, the spreadsheet application resolves the formula and displays the resolved results in the open cell. The intended result is a line of database code, perhaps in a query language such as SQL, that would be executable by a database application to create a table or table entry for the first variable in a database underlying the CDMS system. If the resolved results do not match what the developer expects, he or she may debug the spreadsheet code and test again until it works as expected.

Instead of repeating this coding process for the remainder of the variable rows in the current sheet, the developer would then use the autofill functionality of the spreadsheet application to fill the spreadsheet code into a similar open cell for each of the remaining variables. The cells that now have the applicable spreadsheet code are lined in a column in the active sheet. After the spreadsheet application resolves the filled formula, each of the remaining variables will have database code to construct that variable in the database. Thus, the developer has only coded the database code generating spreadsheet code once, but, is then able to reuse the same code structure through the autofill for the remaining variables.

Next, the developer selects another open cell in the row of the first variable. He or she now enters spreadsheet code interspersed with AS code. The spreadsheet logic is similar to the logic used for the database code. Depending on the various states of some of the variable parameters, selected cell content is concatenated with the AS code snippets to form AS code in the resolved cell. This AS code, when executed by an application server, defines how the application server is to generate a graphical data entry form including that particular variable. Here again, the developer has only coded the AS code generating spreadsheet code once, but is able to reuse the code structure to supply the desired AS code for each of the remaining variables.

The difference in time required by the developer to perform the coding described above as opposed co manually coding the database code and AS code for each variable can be quite large. However, the overall time savings is even greater because once the developer has written the spreadsheet codes for the database and AS codes for the first doctor, those codes may thereafter be copied to the other doctors' worksheets. The developer would copy the spreadsheet codes for the first variable in the first worksheet to corresponding cells in the next worksheet for the first variable in that worksheet. After resolving those spreadsheet codes, database and AS code is provided in the new worksheet. Using the autofill functionality again, the developer provides the requisite database and AS codes for the remaining variables in respective columns of the new worksheet. The developer may then continue to copy and paste the spreadsheet code and then use the autofill functionality to completely code all of the variables in all of the worksheets for the entire research project. All of this code is provided at the cost of only coding the first database code and first AS code for the first variable of the first worksheet.

As the database codes and AS codes are available, the developer copies that code from the spreadsheet application to a database application and an application server environment, respectively. When executed by the database application, the copied database code generates the database stored centrally at central storage 806 that will underlie the CDMS system for the research project. The code creates each table and provides an indexed location for storage of each variable that was defined in the original template and then entered into the spreadsheet. Similarly, the copied AS code is posted at web server 807, which hosts the application server identified to manage the database at central storage 806.

Because the developer has only written two sets of code, with the remaining code having come directly from the original two, errors are minimized in the system. Moreover, if errors do exist, they would exist from the beginning. Therefore, by updating and correcting the original code and then re-filling the remaining code. The developer can easily, efficiently, and reliably manage and correct errors by correcting the original spreadsheet codes and then re-autofilling the respective column in the spreadsheet application. The resulting code may then be transferred back to the requisite entity.

In operation, as patients 801 visit the doctors at test facilities 802-805 and the doctors begin testing and accumulating data on patients 801, the doctors may access the database at central storage 806 through internet 808 and web server 807. FIG. 8B is an idealized diagram illustrating organizational structure 81 of the database generated according to one embodiment of the present teachings. An additional table that is set up in the database when the research project begins is subject ID table 809. Subject ID table 809 contains all of the identifying information for each of patients 801. Government regulations require this information to be handled securely. Therefore, it is kept separately from the rest of the information in the CDMS system. Moreover, field level encryption is used to encrypt all of the identifying information. A non-identifying subject ID is used to index the identifiable information. This subject ID is used in all other tables of test data related to the particular one of patients 801. Organizational structure 80 is a hierarchical organization. It illustrates access privileges to the data entered in the CDMS system. Administrator 800-M represents the access ability for the principal researchers at research institute 800. Each of the principal researchers can access the data entered by any other of the doctors at test facilities 802-805. However, each individual doctor at each of test facilities 802-805 can only see his or her own entered data.

Each doctor at test facilities 802-805 have their own database table in the CDMS for storing test data. Doctors at the same facility are associated together even though each of those doctors can still only access his or her own data. For example, the doctors at test facility 802 each have a separate database table associated with them, Tables 802-T-N. The other doctors at the other facilities 803-805 also have separate tables, Tables 803-T-N, 804-T-N, and 805-T-N. When one of patients 801 visits a doctor at test facility 802 for testing. The doctor logs into web server 807 via internet 808 using the doctor's user ID and password. Based on the doctor's user ID, the application server hosted by web server 807 retrieves the data in the doctor's corresponding table, 802-T. The application server runs the AS code received from the developer resulting from the spreadsheet application resolving the spreadsheet code, as described above. The AS code instructs the application server to generate a graphic data entry form. The form is transmitted to the doctor's computer at test facility 802, which displays the data entry form using a web browser or some other media player. Once the graphical data entry form is viewable, the doctor starts entering the resulting test data to its particular entry field. After the doctor finishes entering the test data, the completed entry form is transmitted back to web server 807 which extracts the data and, using the mapping information that is part of the AS code for the data entry form, places the data at the appropriate location in Table 802-T.

If this doctor wishes to perform his own analysis on his data, he may log into web server 807, again using his or her user ID and password. The application server hosted by web server 807 uses the doctor's user ID to access the CDMS. However, the CDMS only allows that user ID to access the data in Table 802-T, i.e., the doctor's own data table. Therefore, as the doctor requests certain data, the only data that will be served back to him or her is data from Table 802-T. This compartmentalization also maintains a blind standard, which is often required in certain types of research studies. Thus, any analysis performed by this doctor will not be influenced by the test results or test data of any other doctor who is a part of the research study.

Organizational structure 80 also illustrates the access rights to subject ID table 809. As the arrows indicate, the doctors at facilities 802-805 may only place subject ID data into subject ID table 809. None of these doctors may ever view data from subject ID table 809. Only the principal researchers, represented as administrator 800-M, may both read and write to subject ID table 809. Moreover, administrator 800-M has access rights to all of the research data tables, 802-T-N-805-T-N, in the database. By accessing all of this data, the principal researchers may perform project-wide analysis of the test data.

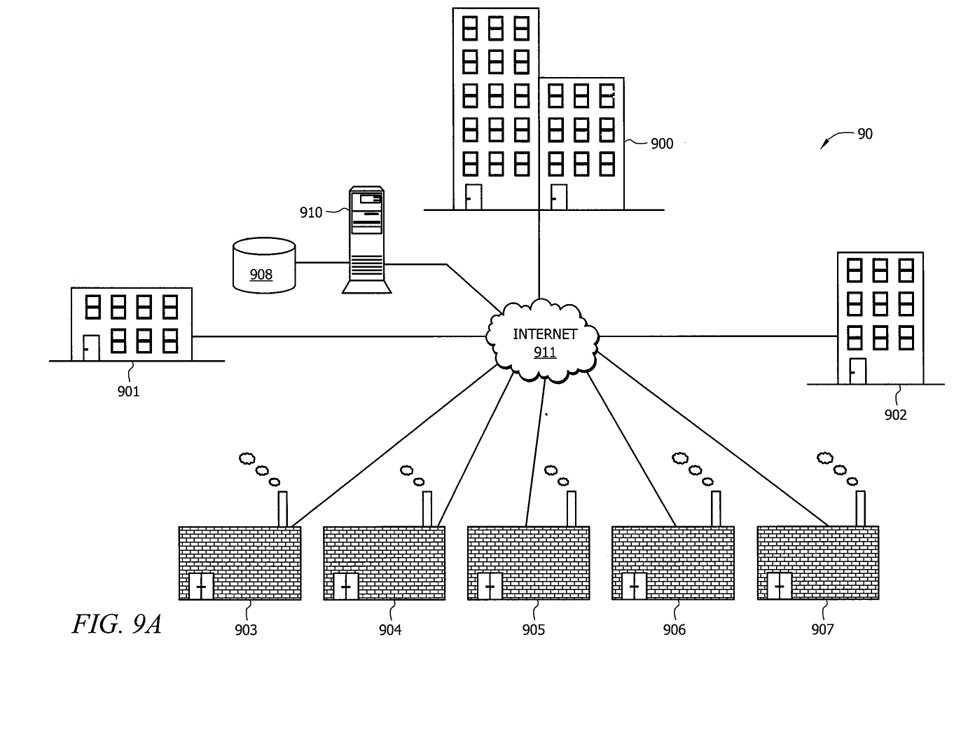

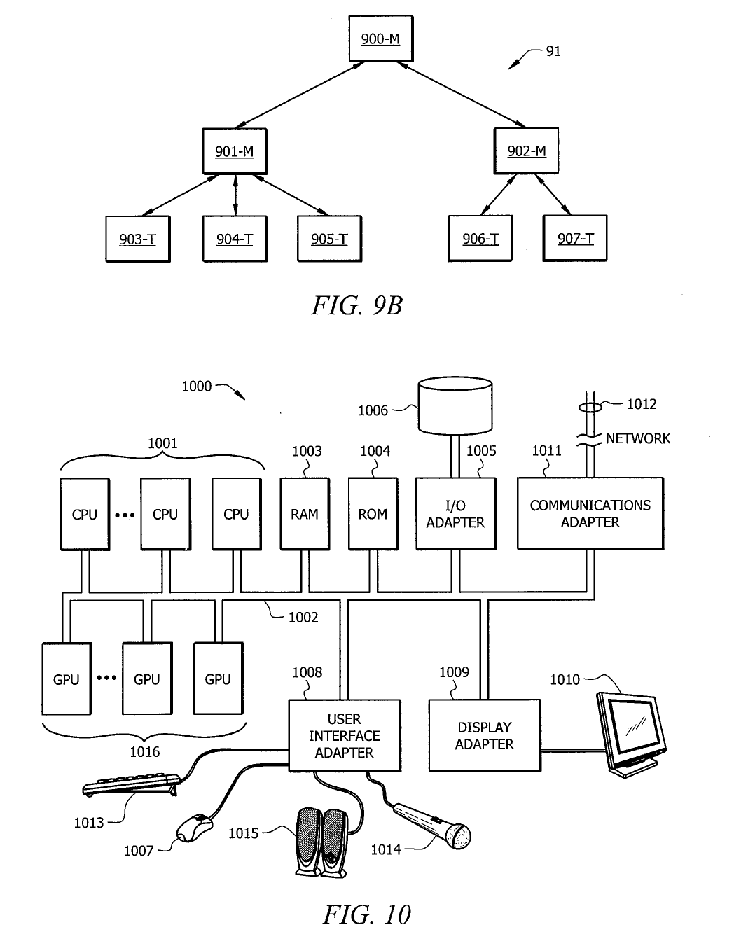

In another application of additional and/or alternative embodiments of the present teachings, industrial data management may be organized and a CDMS for such rapidly developed at a lower cost than many proprietary solutions. FIG. 9A is a block diagram illustrating CDMS 90 created and configured according to one embodiment of the present teachings. CDMS 90 manages the operations of an oil refining company. The oil company is broken down into corporate headquarters 900, regional headquarters 901 and 902, and refineries 903-907. The refining company desires to monitor the production from each of refineries 903-907 in the context of input crude versus output varieties in addition to monitoring the status of the refining process for each stage in each variety production line. In contrast to the medical research study described in FIGS. 8A and 8B, a single team of database developers determine the different variables that are to be measured and recorded. This team then enters those variable parameters into a spreadsheet application. The process for generating the required database and AS codes is the same as identified above. Namely, entering spreadsheet code that, when resolved by the spreadsheet application using the cell contents of the referenced cells, the database and AS codes are produced. The developers may then autofill that spreadsheet code to the remaining variables to produce database and AS codes for all of the database's variables.

Running the database code on a database application produces the database on centralized storage facility 908, managed by web server 910. The AS codes are then uploaded to the application server hosted by web server 910. Data entry for CDMS 90 is also similar to that described in FIGS. 8A and 8B. However, CDMS 90 is also equipped to receive automated data that is measured from plant equipment and sent directly to the database at centralized storage facility 908 over internet 911.

FIG. 9B is an idealized diagram illustrating organizational structure 91 of the database generated according to one embodiment of the present teachings. The data collected for each of refineries 903-907 is stored in its own table, 903-T-907-T, on the database of CDMS 90. Management teams at each of refineries 903-907 may access its own data through the application server hosted on web server 910. However, those refinery-management teams may not access any other refineries' data. Regional headquarters 901 and 902 are represented as regional administrators 901-M and 902-M. Regional administrators 901-M and 902-M may access all of the data that corresponds to the individual refineries within their respective regions. For example, regional administrator 901-M may access and, therefore, analyze the data in tables 903-T-905-T. Likewise, regional administrator 902-M may access and, therefore, analyze the data in tables 906-T and 907-T. Main administrator 900-M, which represents the management team at corporate headquarters 900, can access all of the data, including any analysis data that may be saved by one of regional administrators 901-M and 902-M on the database of CDMS 90.

It should be noted that the example applications described with regard to FIGS. 8A-9B are only two examples of applications for the various embodiments of the present teachings. Any similar application in which a large amount of data is to be managed collected from multiple collaborators would benefit from the various embodiments.

Embodiments, or portions thereof, may be embodied in program or code segments operable upon a processor-based system (e.g., computer system or computing platform) for performing functions and operations as described herein. The program or code segments making up the various embodiments may be stored in a computer-readable medium, which may comprise any suitable medium for temporarily or permanently storing such code. Examples of the computer-readable medium include such tangible computer-readable media as an electronic memory circuit, a semiconductor memory device, random access memory (RAM), read only memory (ROM), erasable ROM (EROM), flash memory, a magnetic storage device (e.g., floppy diskette), optical storage device (e.g., compact disk (CD), digital versatile disk (DVD), etc.), a hard disk, and the like.

Embodiments, or portions thereof, may be embodied in a computer data signal, which may be in any suitable form for communication over a transmission medium such that it is readable for execution by a functional device (e.g., processor) for performing the operations described herein. The computer data signal may include any binary digital electronic signal that can propagate over a transmission medium such as electronic network channels, optical fibers, air, electromagnetic media, radio frequency (RF) links, and the like, and thus the data signal may be in the form of an electrical signal, optical signal, radio frequency or other wireless communication signal, etc. The code segments may, in certain embodiments, be downloaded via computer networks such as the Internet, an intranet, a local area network (LAN), a metropolitan area network (MAN), a wide area network (WAN), the public switched telephone network (PSTN), a satellite communication system, a cable transmission system, and/or the like.

FIG. 10 illustrates an exemplary computer system 1000 which may be employed to implement the developers computer or web server therein according to certain embodiments. Central processing unit (“CPU” or “processor”) 1001 is coupled to system bus 1002. CPU 1001 may be any general-purpose processor. The present disclosure is not restricted by the architecture of CPU 1001 (or other components of exemplary system 1000) as long as CPU 1001 (and other components of system 1000) supports the inventive operations as described herein. As such CPU 1001 may provide processing to system 1000 through one or more processors or processor cores. CPU 1001 may execute the various logical instructions described herein. For example, CPU 1001 may execute machine-level instructions according to the exemplary operational flow described above in conjunction with FIG. 4. When executing instructions representative of the operational steps illustrated in FIG. 4, CPU 1001 becomes a special-purpose processor of a special purpose computing platform configured specifically to operate according to the various embodiments of the teachings described herein.

Computer system 1000 also includes random access memory (RAM) 1003, which may be SRAM, DRAM, SDRAM, or the like. Computer system 1000 includes read-only memory (ROM) 1004 which may be PROM, EPROM, EEPROM, or the like. RAM 1003 and ROM 1004 hold user and system data and programs, as is well known in the art.

Computer system 1000 also includes input/output (I/O) adapter 1005, communications adapter 1011, user interface adapter 1008, and display adapter 1009. I/O adapter 1005, user interface adapter 1008, and/or communications adapter 1011 may, in certain embodiments, enable a user to interact with computer system 1000 in order to input information.

I/O adapter 1005 connects to storage device(s) 1006, such as one or more of hard drive, compact disc (CD) drive, floppy disk drive, tape drive, etc., to computer system 1000. The storage devices are utilized in addition to RAM 1003 for the memory requirements associated with providing storage of the database for a compatible CDMS or for storing the spreadsheet, database, and application environment applications used in rapid development of the CDMS systems. Communications adapter 1011 is adapted to couple computer system 1000 to network 1012, which may enable information to be input to and/or output from system 1000 via such network 1012 (e.g., the Internet or other wide-area network, a local-area network, a public or private switched telephony network, a wireless network, any combination of the foregoing). User interface adapter 1008 couples user input devices, such as keyboard 1013, pointing device 1007, and microphone 1014 and/or output devices, such as speaker(s) 1015 to computer system 1000. Display adapter 1009 is driven by CPU 1001 or by graphical processing unit (GPU) 1016 to control the display on display device 1010 to, for example, display the spreadsheet application used for the development process, for displaying the graphical data entry forms received from the application server, and the like. GPU 1016 may be any various number of processors dedicated to graphics processing and, as illustrated, may be made up of one or more individual graphical processors. GPU 1016 processes the graphical instructions and transmits those instructions to display adapter 1009. Display adapter 1009 further transmits those instructions for transforming or manipulating the state of the various numbers of pixels used by display device 1010 to visually present the desired information to a user. Such instructions include instructions for changing state from on to off, setting a particular color, intensity, duration, or the like. Each such instruction makes up the rendering instructions that control how and what is displayed on display device 1010.

It shall be appreciated that the present disclosure is not limited to the architecture of system 1000. For example, any suitable processor-based device may be utilized for implementing the rapid development system, including without limitation personal computers, laptop computers, computer workstations, multi-processor servers, and even mobile telephones. Moreover, certain embodiments may be implemented on application specific integrated circuits (ASICs) or very large scale integrated (VLSI) circuits. In fact, persons of ordinary skill in the art may utilize any number of suitable structures capable of executing logical operations according to the embodiments.

Although the present teachings and their advantages have been described in detail, it should be understood that various changes, substitutions and alterations can be made herein without departing from the spirit and scope of the teachings as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present teachings, processes, machines, manufacture, compositions of matter, means, methods, or steps, presently existing or later to be developed that perform substantially the same function or achieve substantially the same result as the corresponding embodiments described herein may be utilized according to the present teachings. Accordingly, the appended claims are intended to include within their scope such processes, machines, manufacture, compositions of matter, means, methods, or steps.

What is claimed is:

1. A method for developing a collaborative database management system in a spreadsheet application, said method comprising:
entering each of one or more parameters into a cell of an active sheet of said spreadsheet application, wherein said one or more parameters relate to a first variable of a plurality of database variables;
entering first spreadsheet code identifying selected ones of said one or more parameters, wherein said first spreadsheet code resolves into database code instructions instructing a database application to create said first variable in a database;
entering second spreadsheet code identifying additional selected ones of said one or more parameters, wherein said second spreadsheet code resolves into application server (AS) code instructions instructing an application server to generate a graphical data entry form for said first variable and including mapping instructions mapping an entry field for said first variable to said first variable in said database; and
autofilling said first and second spreadsheet codes for remaining variables of said plurality of database variables, wherein results of said autofilling creates additional database code instructions and additional AS code instructions for said remaining variables.

2. The method of claim 1 further comprising:
creating a template of said plurality of database variables, wherein said creating is performed by one or more of:
a database designer; and
one or more testers identified to collect data for said collaborative database management system.

3. The method of claim 1 further comprising:
entering access restrictions to said plurality of variables in said database.

4. The method of claim 3 wherein said entering access restrictions comprises:
entering third spreadsheet code identifying said first variable and access privileges to said first variable, wherein said third spreadsheet code resolves into database security code instructing said database application to establish access privileges to said first variable;
autofilling said third spreadsheet code for remaining variables of said plurality of database variables;
manually updating said resolved third spreadsheet code for said plurality of database variables to customize said access privileges for each of said plurality.

5. The method of claim 3 wherein said entering access restrictions comprises:
coding said access restrictions to said database using said database application.

6. The method of claim 3 further comprising:
establishing an administrator access that allows access to all of said plurality of variables in said database.

7. The method of claim 1 wherein said second spreadsheet code includes verification code based on a value of said additional selected ones of said one or more parameters, wherein said AS code additionally instructs said application server to generate said graphical data entry forms with verification functionality to verify user input according to said verification code.

8. The method of claim 7 wherein said AS code additionally instructs said application server to include functionality to prompt a user to re-enter said user input in response to a failure to verify said user input.

9. A method for building a collaborative database management system, said method comprising:
receiving one or more parameters for each of a plurality of database variables into a spreadsheet running on a computer, wherein each of said one or more parameters is placed into its own cell displayed on a visual display of said computer;
receiving a first spreadsheet formula associated with a first variable of said plurality of database variables, said first spreadsheet formula identifying selected ones of said one or more parameters of said first variable;
responsive to resolution of said first spreadsheet formula, displaying a first database code in a corresponding cell displayed on said visual display, wherein said first database code instructs a database application to create said first variable in a database;
receiving a second spreadsheet formula associated with said first variable, said second spreadsheet formula identifying additional selected ones of said one or more parameters of said first variable;
responsive to resolution of said second spreadsheet formula, displaying a first application server (AS) code in a corresponding cell displayed on said visual display, wherein said first AS code instructs an application server to generate a graphical data entry form associated with said first variable, and wherein said first AS code includes mapping instructions mapping an entry field in said graphical data entry form to said first variable in said database;
autofilling said first and second spreadsheet codes into one or more additional cells corresponding to remaining ones of said plurality of database variables, wherein said autofilling generates additional database and AS codes for each of said remaining ones of said plurality of database variables.

10. The method of claim 9 wherein said cells holding said one or more parameters are arranged in a linear, consecutive order and wherein said cells holding said database code and said AS code are also arranged in said linear, consecutive order.

11. The method of claim 9 wherein said first spreadsheet code includes one or more cell references and one or more database code words, and wherein said second spreadsheet code includes one or more additional cell references and one or more AS code words.

12. A computer program product having a computer readable medium with computer program logic recorded thereon, said computer program product comprising:
code for receiving input of each of one or more parameters into a cell of an active sheet of a spreadsheet application, wherein said one or more parameters relate to a first variable of a plurality of database variables in a collaborative database management system;
code for receiving input of first spreadsheet code identifying selected ones of said one or more parameters, wherein said first spreadsheet code resolves into database code instructions instructing a database application to create said first variable in a database;
code for receiving input of second spreadsheet code identifying additional selected ones of said one or more parameters, wherein said second spreadsheet code resolves into application server (AS) code instructions instructing an application server to generate a graphical data entry form for said first variable and including mapping instructions mapping an entry field for said first variable to said first variable in said database; and
code for autofilling said first and second spreadsheet codes for remaining variables of said plurality of database variables, wherein results of said autofilling creates additional database code instructions and additional AS code instructions for said remaining variables.

13. The computer program product of claim 12 further comprising:
code for receiving input of access restrictions to said plurality of variables in said database.

14. The computer program product of claim 13 wherein said code for receiving input of access restrictions comprises:
code for receiving input of third spreadsheet code identifying said first variable and access privileges to said first variable, wherein said third spreadsheet code resolves into database security code instructing said database application to establish access privileges to said first variable;
code for autofilling said third spreadsheet code for remaining variables of said plurality of database variables;
code for receiving manual updates to said resolved third spreadsheet code for said plurality of database variables to customize said access privileges for each of said plurality.

15. The computer program product of claim 13 wherein said code for entering access restrictions comprises:
code for receiving said access restrictions to said database using said database application.

16. The computer program product of claim 13 further comprising:
code for establishing an administrator access that allows access to all of said plurality of variables in said database.

17. The computer program product of claim 12 wherein said second spreadsheet code includes verification code based on a value of said additional selected ones of said one or more parameters, wherein said AS code additionally instructs said application server to generate said graphical data entry forms with verification functionality to verify user input according to said verification code.

18. The computer program product of claim 17 wherein said AS code additionally instructs said application server to include functionality to prompt a user to re-enter said user input in response to a failure to verify said user input.

19. A computer program product having a computer readable medium with computer program logic recorded thereon, said computer program product comprising:
code for receiving one or more parameters for each of a plurality of database variables into a spreadsheet running on a computer, wherein each of said one or more parameters is placed into its own cell displayed on a visual display of said computer;
code for receiving a first spreadsheet formula associated with a first variable of said plurality of database variables, said first spreadsheet formula identifying selected ones of said one or more parameters of said first variable;
code, executable responsive to resolution of said first spreadsheet formula, for displaying a first database code in a corresponding cell displayed on said visual display, wherein said first database code instructs a database application to create said first variable in a database;
code for receiving a second spreadsheet formula associated with said first variable, said second spreadsheet formula identifying additional selected ones of said one or more parameters of said first variable;
code, executable responsive to resolution of said second spreadsheet formula, for displaying a first application server (AS) code in a corresponding cell displayed on said visual display, wherein said first AS code instructs an application server to generate a graphical data entry form associated with said first variable, and wherein said first AS code includes mapping instructions mapping an entry field in said graphical data entry form to said first variable in said database; and
code for autofilling said first and second spreadsheet codes into one or more additional cells corresponding to remaining ones of said plurality of database variables, wherein said code for autofilling generates additional database and AS codes for each of said remaining ones of said plurality of database variables.

20. The computer program product of claim 19 wherein said cells holding said one or more parameters are arranged in a linear, consecutive order and wherein said cells holding said database code and said AS code are also arranged in said linear, consecutive order.

21. The computer program product of claim 19 wherein said first spreadsheet code includes one or more cell references and one or more database code words, and wherein said second spreadsheet code includes one or more additional cell references and one or more AS code words.
